(19) United States
(12) Patent Application Publication
(10) Pub. No.: US 2007/0011632 A1
(43) Pub. Date: Jan. 11, 2007

(54) SYSTEM AND METHOD FOR COMPARING TWO CIRCUIT DESIGNS

(76) Inventor: Da-Jun Yang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,783

(22) Filed: May 3, 2006

(30) Foreign Application Priority Data
Jun. 22, 2005 (CN) 200510035507.1

(51) Int. Cl. G06F 17/50

(52) U.S. Cl. 716/5; 716/3

(57) ABSTRACT

A method for comparing a new circuit design with a corresponding old circuit design is disclosed. The method includes the steps of: creating two components attributes documentations according to a new circuit design and a corresponding old circuit design; receiving the two components attributes documentations; comparing the two components attributes documentations; and outputting the comparison results. By utilizing the present invention, the two circuit designs can be compared in the same interface, and comparison results are obtained and displayed quickly and accurately.

### FIELD OF THE INVENTION

The present invention relates to the field in circuit designing, and more particularly to a system and method for comparing component relationships in two circuit designs.

### DESCRIPTION OF RELATED ART

Circuit designers may design a new circuit design on a basis of an old circuit design without too much modification. They may find the difference of the two circuit designs after the new circuit design has been finished. Such differences may include different components, different component relations, and components' different values. The traditional method uses a software tool for comparing the components attributes documentations of the two circuit designs. The tool marks and highlights the differences of the two circuit designs in two graphical interfaces, however the comparison result is not obvious enough. Especially in a large circuit designing, it is a hard and time-consuming work for designers to find every difference between two circuit designs.

To avoid incorrect comparison results and spending too much time in two circuit comparison, what is needed, therefore, is a system and method that can compare two circuit designs with only one interface, such that the comparison results are accurate, and obtained and displayed quickly.

### SUMMARY OF INVENTION

A system for comparing two circuit designs is provided in accordance with a preferred embodiment. The system includes a components attributes documentation creating module, a document receiving module, a comparing module and an outputting module. The components attributes documentation creating module is used for creating two components attributes documentations according to the new circuit design and the old circuit design, each of the two components attributes documentations is a document containing corresponding data that includes a component segment and a node segment. The document receiving module is used for receiving the two components attributes documentations. The comparing module is used for comparing the two components attributes documentations. The outputting module is used for outputting the comparison results.

A preferred method for comparing a new circuit design with a corresponding old circuit design is provided. The method includes the steps of: creating two components attributes documentations according to the new circuit design and the old circuit design respectively; receiving the two components attributes documentations; comparing the two components attributes documentations; and outputting the comparison results.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating hardware configuration of a system for comparing two circuit designs in accordance with one embodiment;

FIG. 2 is a schematic diagram of software function modules of a system for comparing two circuit designs in accordance with one embodiment; and

FIG. 3 is a flowchart of a preferred method for comparing two circuit designs.

### DETAILED DESCRIPTION

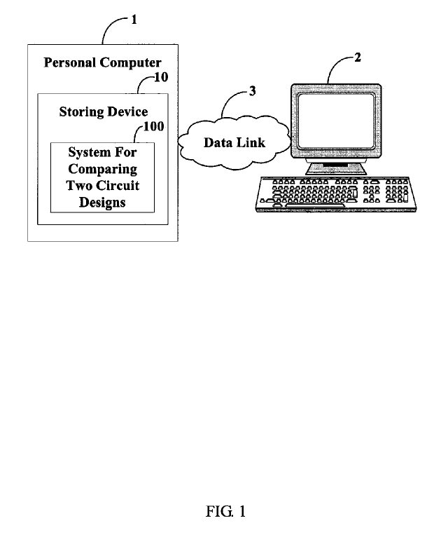

FIG. 1 is a schematic diagram illustrating hardware configuration of a system for comparing two circuit designs in accordance with one embodiment. The hardware configuration typically includes a personal computer 1 that is connected with a monitor 2 via a data link 3. The personal computer 1 mainly includes a storing device 10. In the preferred embodiment, the storing device 10 also can be configured as, for example, but not limited to, a server, a personal digital assistant, or the like. The storing device 10 stores a system for comparing two circuit designs (hereinafter, “the system 100”), and data related for the comparison, such as components attributes documentations. The monitor 2 is used for displaying comparison results.

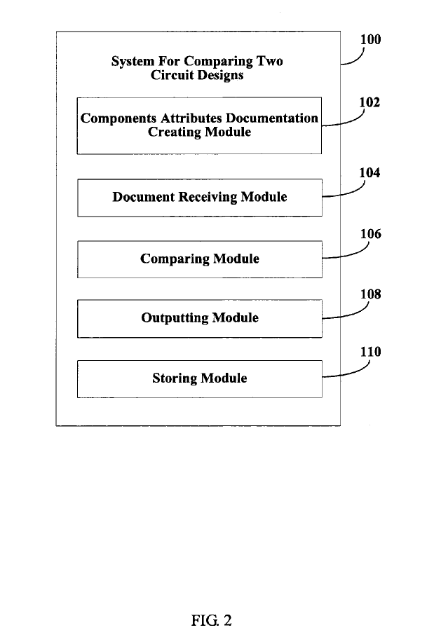

FIG. 2 is a schematic diagram of software function modules of the system 100 in FIG. 1, in accordance with one preferred embodiment. The system 100 mainly includes: a components attributes documentation creating module 102, a document receiving module 104, a comparing module 106, an outputting module 108, and a storing module 110.

The components attributes documentation creating module 102 is used for creating two components attributes documentations. Each components attributes documentation is either based on a new circuit design or its corresponding old circuit design that is to be compared. It contains corresponding data that are used for comparison. A components attributes documentation typically includes two segments: a component segment and a node segment. In the component segment, each row represents a unique component's information. For example, in a row listed with tuple “C0603! 0.1 uF; C100,” the first field “C0603” is a component footprint; the second field “0.1 uF” is the value of the component; and the third field “C100” is the component's name. In the node segment, the format of a node listing is represented as: “node's name; point of connection,” and the format of the point of connection is “node's name. Pin”. For example, in a node listing “M_DQS_P_B5; U16.AP36 DIMM4.93 DIMM3.94,” “M_DQS_P_B5” is the node's name; “AP36,” “93,” and “94” are pins of the node, and each pin is connected with a component such that pin “AP36” is connected with a component named “U16,” pin “93” is connected with a component named “DIMM4,” and pin “94” is connected with a component named “DIMM3”.

The document receiving module 104 and the comparing module 106 is used for receiving and comparing the two components attributes documentations respectively. The comparing module 106 is further used for generating comparison results. The results are then outputted by the outputting module 108 and displayed on the monitor 2. The comparison results may include, for example, values, connection points relationships, footprints on all equivalent components and a list of all different components between the two circuit designs. The storing module 110 is used for saving the comparison results. For example, the storing module 110 saves the comparison results into a text file in order for the convenience of designing a new circuit. If there are fully identical tuples or nodes in the pair of components attributes documentations, the outputting module 108 outputs suggestive information (i.e. they are the same) instead.

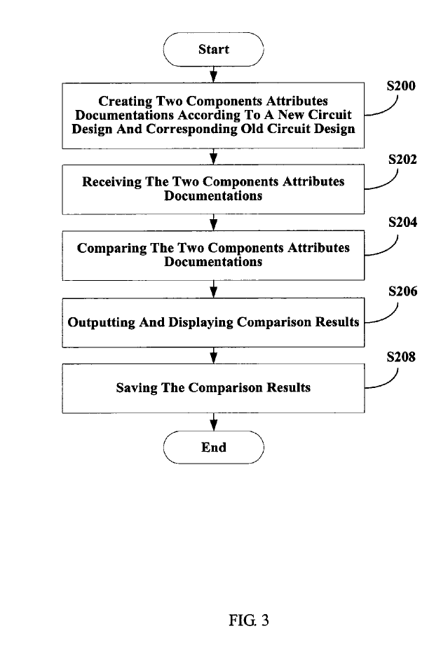

FIG. 3 is a flowchart of a preferred method for comparing two circuit designs by utilizing the system 100. In step S200, the components attributes documentation creating module 10 creates two components attributes documentations according to a new circuit design and it's corresponding old circuit design. Each components attributes documentation is a document containing corresponding data that includes a component segment and a node segment, such data are used for comparison, for example, values, connection points relationships and footprints. In step S202, the document receiving module 104 receives the two components attributes documentations. In step S204, the comparing module 106 compares the two components attributes documentations, compares and contrasts the two circuit designs, and generates the comparison results. In step S206, the outputting module 108 outputs the comparison results and displays them on the monitor 2. The comparison results may include different values, connection points' relationships, footprints, and nodes on all equivalent components, and a list on all different components between the two circuit designs. In step S208, the storing module 110 saves the comparison results into a text file in order for convenience of designing a new circuit. If there are fully identical tuples or nodes in the pair of components attributes documentations, the outputting module 108 outputs suggestive information (i.e. they are the same) instead.

It is to be understood that, in step S204, the comparing module 106 cannot compare nodes by utilizing the nodes' names. Upper case and lower case letters are also insignificant, when nodes' names of the components are identical.

It is also to be understood that, in step S206, the two comparing nodes that are displayed in the comparison results must have the most same nodes.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for comparing two circuit designs, the system comprising:
a components attributes documentation creating module for creating two components attributes documentations according to the two circuit designs, each of the two components attributes documentations is a document containing corresponding data that includes a component segment and a node segment;
a document receiving module for receiving the two components attributes documentations;
a comparing module for comparing the two components attributes documentations; and
an outputting module for outputting the comparison results.

2. The system as claimed in claim 1, further comprising a storing module for saving the comparison results.

3. The system as claimed in claim 1, wherein the comparing module is further used for comparing different components, different component relations, components' different values and footprints between the two circuit designs.

4. The system as claimed in claim 1, wherein the comparison results comprising the same parts and the differences between the two circuit designs.

5. A method for comparing a new circuit design with a corresponding old circuit design, the method comprising the steps of:
creating two components attributes documentations according to the new circuit design and the corresponding old circuit design respectively;
receiving the two components attributes documentations;
comparing the two components attributes documentations; and
outputting the comparison results.

6. The method according to claim 5, wherein the step of comparing the two components attributes documentations comprises the step of comparing different components, different component relations, components' different values and footprints between the two circuit designs.

7. The method according to claim 5, further comprising the step of storing the comparison results.
